(19) United States
(12) Patent Application Publication
(10) Pub. No.: US 2022/0162784 A1
(43) Pub. Date: May 26, 2022

(54) LAYERED PRODUCT OBTAINED FROM PRE-CONSUMPTION WASTE ORIGINATING FROM PRODUCTS BASED ON CAMEL AND/OR CASHMERE AND/OR ALPACA AND/OR MOHAIR AND/OR WOOL AND/OR YAK AND METHOD FOR PROVIDING THE PRODUCT

(71) Applicant: IMBOTEX LAB S.R.L., CITTADELLA (IT)

(72) Inventors: Stefania CARNIELLO, CITTADELLA (IT); Ignazio MARAMOTTI, ALBINEA (IT)

(73) Assignee: IMBOTEX LAB S.R.L., CITTADELLA (IT)

(21) Appl. No.: 17/440,861

(22) PCT Filed: Mar. 4, 2020
(86) PCT No.: PCT/EP2020/055665

§ 371 Date: Sep. 20, 2021

(30) Foreign Application Priority Data
Mar. 21, 2019 (IT) 102019000004101

(51) Int. Cl. D04H 1/4266; D04H 1/4274; D04H 1/541; D01G 21/00

(52) U.S. Cl. CPC D04H 1/4266; D01G 21/00; D04H 1/5418; D04H 1/4274

(57) ABSTRACT

A layered product obtained from pre-consumption waste originating from products based on camel and/or Cashmere and/or alpaca and/or mohair and/or wool and/or yak and/or the like; the product comprises, in percentages by weight:
recovered high-value fibers between 30% and 60%,
tufts of recycled plastic material between 5% and 50%,
tufts of two-part plastic material and with low-melting outside between 8% and 30%.

The present invention relates to a layered product obtained from pre-consumption waste originating from products based on high-value fibers.

The present invention also relates to the method for providing such a product.

The expression “high-value fibers” references, in the present description, fibers of natural origin that are of high value and are well-known to the person skilled in the art.

These include, for example, camel fibers, Cashmere fibers, alpaca fibers, mohair fibers, wool fibers, yak fibers, and the like.

High-value fibers are currently used particularly in the luxury market for the production and manufacture of items of clothing.

These fibers are usually spun and processed so as to form a woven raw material.

Various parts are then cut from this raw material to assemble the item of clothing.

In order to limit waste, in recent years increasingly sophisticated equipment capable of maximizing the use of the raw material cited above have become established on the market.

This equipment generally but not exclusively performs automatic cuts after positioning.

However, these known methods do not eliminate the production of waste which causes: on the one hand, the drawback of generating a waste of material that cannot be used for the production of the items, on the other hand the need to dispose of these residues.

In order to be able to recover this waste and be able to reuse the fibers in other applications, methods have been developed which allow to recover the fibers through a chemical process.

In the present description, the term “recovery” means “method suitable to obtain a material in order to reuse it instead of disposing of it” and the term “recovered” means “material obtained from the recovery operation”.

These methods have drawbacks.

In order to be able to recover fibers through a chemical process, the waste is immersed in vats of an aqueous solution additized with chemical solvents adapted to break up the bonds between them.

This aqueous solution forms sludge which must subsequently be disposed, generating environmental pollution problems.

Another method for recovering fibers from waste consists in rag-tearing and/or rag-grinding them with water and subsequently drying the fibers with air.

This causes an expenditure of energy and resources both for the rag-tearing/rag-grinding step and for the drying step. Moreover, the water used for the rag-tearing/rag-grinding step becomes dirty and must be subsequently disposed.

Furthermore, with currently known waste recovery methods, one obtains products that are qualitatively inferior or not comparable with similar consumer products composed of virgin high-value fibers.

Moreover, waste recovery uses energy resources and toxic emissions which are often equal to or greater than those for the production of products based on virgin high-value fibers.

The expression “virgin high-value fibers” in the present description refers to products such as for example:
dehaired camel hair/wool,
and/or dehaired Cashmere hair/wool,
and/or dehaired yak hair/wool,
and/or dehaired alpaca hair/wool,
and/or fiber taken from sheep fleece,
and/or the like.

The term “dehaired” refers, in the present description, to the fact that the hair is subjected to a process, well-known to the person skilled in the art, adapted to eliminate any vegetable materials, scurf and external bristly hairs.

The need is therefore felt to develop a method for providing a product obtained from pre-consumption waste based on “high-value fibers” that has a reduced environmental impact and allows the recovery of the fibers with the provision of a layered product that is qualitatively comparable, for example from the thermal standpoint, if not superior, with respect to a similar layered consumer product composed of virgin high-value fibers.

The aim of the present invention is to devise a method for providing a layered product obtained from pre-consumption waste originating from products based on camel and/or Cashmere and/or alpaca and/or mohair and/or wool and/or yak and/or the like, and a product that is capable of improving the background art in one or more of the aspects indicated above.

Within this aim, an object of the invention is to provide a method for providing a layered product obtained from pre-consumption waste originating from products based on camel and/or Cashmere and/or alpaca and/or mohair and/or wool and/or yak and/or the like.

Another object of the invention is to devise a method for providing a layered product obtained from pre-consumption waste originating from products based on camel and/or Cashmere and/or alpaca and/or mohair and/or wool and/or yak and/or the like that has a lower environmental impact than similar methods of the known type.

A further object of the invention is to provide a method for providing a layered product obtained from pre-consumption waste originating from products based on camel and/or Cashmere and/or alpaca and/or mohair and/or wool and/or yak and/or the like that has qualitative characteristics comparable with those of similar layered consumer products composed of virgin high-value fibers.

Another object of the invention is to provide a layered product obtained from pre-consumption waste originating from products based on camel and/or Cashmere and/or alpaca and/or mohair and/or wool and/or yak and/or the like.

A further object of the invention is to provide a layered product obtained from pre-consumption waste originating from products based on camel and/or Cashmere and/or alpaca and/or mohair and/or wool and/or yak and/or the like and a method for providing it that are highly reliable, relatively easy to provide and at competitive costs.

This aim, as well as these and other objects which will become better apparent hereinafter, are achieved by a layered product obtained from pre-consumption waste originating from products based on camel and/or Cashmere and/or alpaca and/or mohair and/or wool and/or yak and/or the like, characterized in that it comprises, in percentages by weight:
recovered high-value fibers between 30% and 60%,
tufts of recycled plastic material between 5% and 50%,
tufts of two-part plastic material and with low-melting outside between 8% and 30%.

Said product is obtained by means of a method that consists in:
mixing said high-value fibers with tufts of recycled plastic material and tufts of two-part plastic material with low-melting outside, obtaining a mixed product,
carding said mixed product, obtaining a uniformly mixed and carded layer,
layering said uniformly mixed and carded layer, obtaining a layered product,
stretching said layered product, obtaining a layered product of uniform thickness,
subjecting said layered product of uniform thickness to a thermal bonding operation, melting and mutually heat-sealing at least the external part of said tufts of two-part plastic material so as to form a three-dimensional containment mesh for said high-value fibers and for said tufts of recycled plastic material.

Further characteristics and advantages of the invention will become better apparent from the description of a preferred but not exclusive embodiment of the method for providing a layered product obtained from pre-consumption waste originating from products based on camel and/or Cashmere and/or alpaca and/or mohair and/or wool and/or yak and/or the like, illustrated by way of nonlimiting example in the accompanying drawings, wherein:

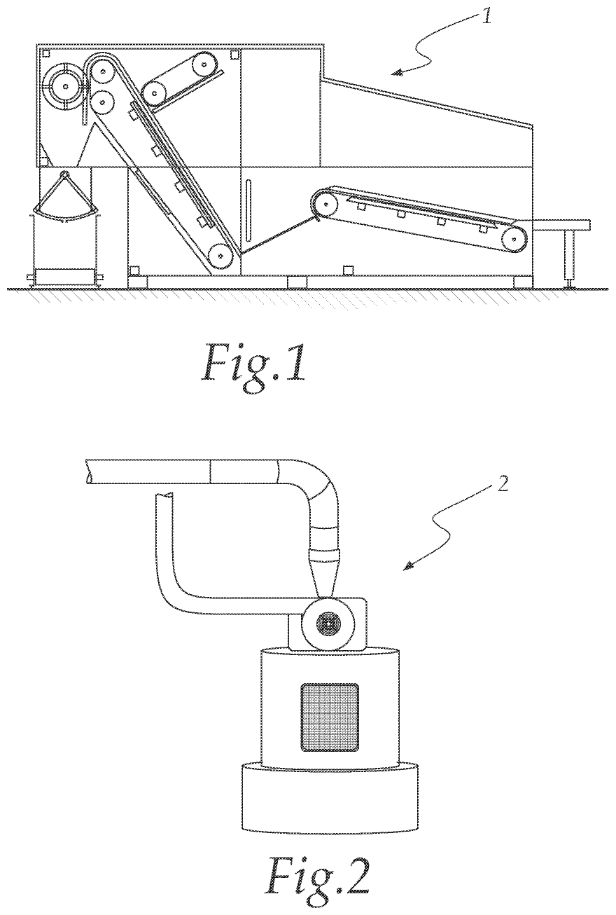

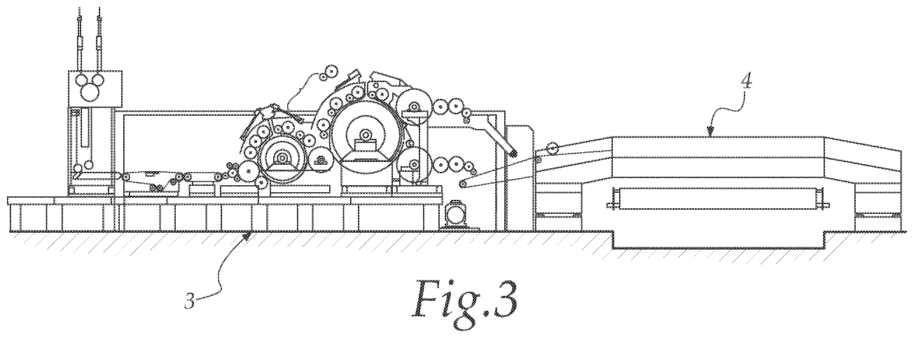

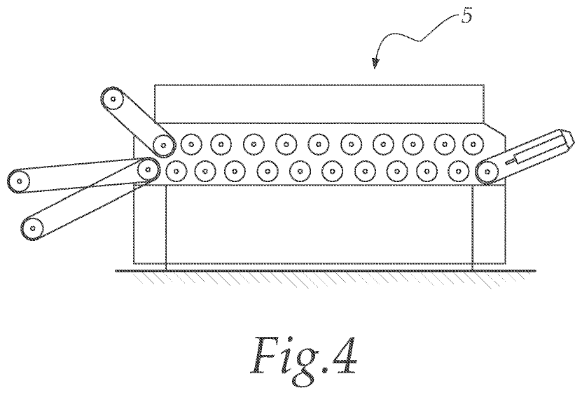

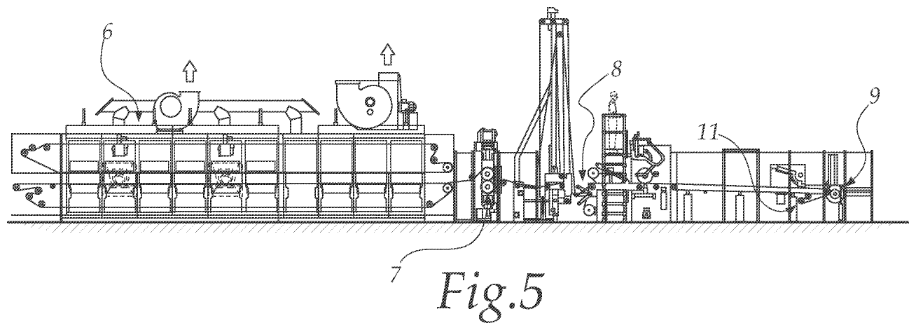

FIGS. 1 to 5 are schematic views of different steps of a method for providing a layered product obtained from pre-consumption waste originating from products based on camel and/or Cashmere and/or alpaca and/or mohair and/or wool and/or yak and/or the like according to the invention;

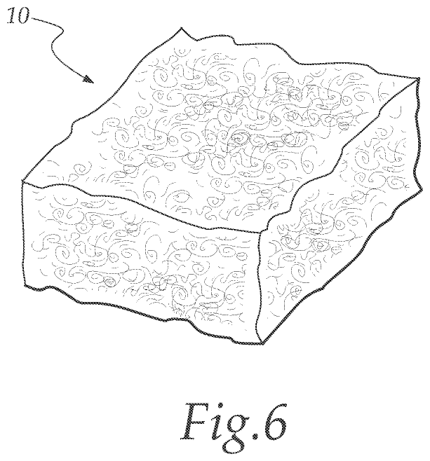

FIG. 6 is a general view of a detail of a layered product obtained from pre-consumption waste originating from products based on camel and/or Cashmere and/or alpaca and/or mohair and/or wool and/or yak and/or the like according to the invention.

The method for providing a layered product obtained from pre-consumption waste originating from products based on camel and/or Cashmere and/or alpaca and/or mohair and/or wool and/or yak and/or the like according to the invention begins with the garnetting of the waste, not shown in the figures.

Waste based on high-value fibers, for example based on camel fibers, is generally palletized.

In the description, the terms “waste” and “scraps” are used with the same meaning.

These pallets of waste are broken up and subjected to garnetting.

During the garnetting step, a sort of powder formed by short fibers, on the order of a few millimeters, is obtained.

These very short high-value fibers are then compressed to form packed blocks.

These blocks are subjected to opening, by means of an opening unit 1 which allows to release the recovered high-value fibers garnetted earlier.

The term “opening” refers, on the textile level, to the operation for opening up the fibers.

The step for packing and subsequent opening of the blocks is not necessary if the method is performed continuously, but it is necessary if the method is performed in steps that are spaced over time and/or in space.

During the opening step, the high-value fibers are released and become volatile again.

These fibers are selected, by means of load cells, as a function of the layered product and of the corresponding thicknesses and weight that one wishes to obtain.

Likewise, in at least two other opening units, not shown in the figures, tufts of recycled plastic material and tufts of two-part plastic material with low-melting outside are released and weighed respectively.

After the opening step, the high-value fibers are mixed, inside a mixer 2, with the tufts of recycled plastic material and the tufts of two-part plastic material and with low-melting outside.

In particular, in an advantageous embodiment of the invention, the high-value fibers are mixed with recycled polyester tufts according to criteria set by the GRS (Global Recycled Standard).

The product thus mixed advances on conveyor belts and is subjected to carding, through a carding unit 3, obtaining a uniformly mixed and carded layer.

This layer is subjected to layering inside a layering unit 4.

“Layering” is the operation of superimposing multiple layers.

A layered product is obtained in this manner.

The layered product thus obtained is subjected to stretching in a stretching unit 5.

The stretching unit 5 gives the layered product a uniform thickness.

The stretching unit 5, inserted after the layering process, is used to ensure a pre-binding action in order to render the layer more uniform.

In the present description, the term “pre-bonding” refers to a reorientation of the layered fibers.

By virtue of the use of cylinders actuated at a progressive speed, the layered fibers are reoriented and the MD (machine direction) and CD (cross direction) ratio is adjustable and is compensated according to preset values.

After stretching, the layered product passes through an oven 6 for thermal bonding.

During this step, at least the external part of the tufts of two-part plastic material with low-melting outside melt, mutually heat-sealing so as to form a three-dimensional containment mesh for the high-value fibers and for the tufts of recycled plastic material.

A thermally bonded layered product is thus obtained.

The tufts of two-part plastic material with low-melting outside melt at a temperature on the order of 140-160° C.

The product is then calendered through the calendering unit 7, cut through a cutter 11, and is rolled up by means of the rolling-up unit 9.

A buffer unit 8 is arranged between the rolling-up unit 9 and the oven 6 and is adapted to accumulate the layered product 10 that exits from the oven continuously, avoiding stretchings of the layer during the step for cutting and replacement of the roll of rolled-up product 10.

One of the particularities of the invention resides in that the entire method complies with the criteria established by the GRS (Global Recycled Standard).

It should be noted that the method is entirely mechanical and not chemical, thus reducing the environmental impact.

The method according to the invention can be performed continuously or in successive steps.

The operations for: garnetting, mixing, carding, layering, stretching, thermal bonding, calendering, cutting and rolling up are operations that are well-known to the person skilled in the art and are performed with per se known equipment.

The invention also relates to a product 10 obtained with the method described above.

In an advantageous embodiment of the invention, the layered product 10 obtained from pre-consumption waste originating from products based on camel and/or Cashmere and/or alpaca and/or mohair and/or wool and/or yak and/or the like comprises, in percentages by weight:
recovered high-value fibers between 30% and 60%,
tufts of recycled plastic material between 5% and 50%,
tufts of two-part plastic material and with low-melting outside between 8% and 30%.

In particular, in a first embodiment the product 10 comprises, in percentages by weight:
substantially 52% camel fibers recovered from garnetted fabric waste, according to the GRS standard,
substantially 28% of recycled polyester tufts according to the GRS standard,
substantially 20% of tufts of two-part plastic material with low-melting outside, with a linear density of 2.2 dtex.

In a second embodiment, the product 10 comprises, in percentages by weight:
substantially 52% of camel fibers recovered from garnetted fabric waste, according to the GRS standard,
substantially 23% of tufts of recycled polyester according to the GRS standard,
substantially 25% of tufts of two-part plastic material with low-melting outside, with a linear density of 2.2 dtex.

In a third embodiment, the product 10 comprises, in percentages by weight:
substantially 52% of camel fibers recovered from garnetted fabric waste, according to the GRS standard,
substantially 23% of tufts of recycled polyester according to the GRS standard,
substantially 25% of tufts of two-part plastic material with low-melting outside, with a linear density of 2.2 dtex,

and has a plurality of holes.

Such holes in turn have a depth of 3.5 mm and a mutual distance between two consecutive holes of 30 mm.

In particular, the product 10 in some constructive variations comprises polyester tufts with a linear density comprised between 1.4 dtex and 6.1 dtex and a length comprised between 30 mm and 70 mm, preferably between 32 mm and 63 mm.

The product 10 can comprise polyester tufts of the type known by the abbreviation “4H” (four hollow).

The product 10 can comprise tufts of two-part plastic material with low-melting outside, with a linear density of 4.4 dtex.

These recovered high-value fibers can, in some embodiments not shown in the figures, be mixed with virgin high-value fibers, such as:
silk,
camel,
wool,
alpaca,
Cashmere,
mohair,
yak,

and/or vegetable fibers such as:
Tencel,
cupro,
linen,
hemp,
bamboo,

and/or biodegradable polyester and/or polyamide fibers.

The recovered high-value fibers can also be mixed, in constructive variations not shown in the figures, with technical fibers based on polyester and elastomers and/or tufts of polyester with heat-reactive minerals and/or fibers containing graphite and/or graphene oxides.

In order to increase the breathability of the article obtained by means of the use of the product 10, it is possible to perform an operation for perforation of the product. This operation can be performed continuously but also at a later time.

Experimental tests performed at the Institute INNOVHUB—STAZIONI SPERIMENTALI PER L'INDUSTRIA in Milan show that the thermal resistance value of the product 10 is even greater than the thermal resistance of a similar consumer product composed of virgin high-value camel fibers.

The values obtained are listed in the table:

| | Consumer | Product 10 based |
|---|---|---|
| | product with virgin | on recovered camel |
| | camel fibers (80 g/m²) | fibers (80 g/m²) |
| Average thermal | 0.16 | 0.19 |
| resistance | | |
| [m²K/W] | | |

In a constructive variation, not shown in the figures, after the garnetting operation it is possible to perform a treatment with ozone and/or oxygen on the short fibers previously obtained.

This treatment renders the fibers soft, hygroscopic, odorless and vapor-permeable, and allows to keep these characteristics unchanged even after several washes.

Furthermore, this treatment releases no noxious element into the fibers or into the environment during its execution.

Preferably, this treatment with ozone and/or oxygen is performed with radical oxygen, a considerably reactive form of oxygen.

By means of radical oxygen, the hydrophilic groups that are already naturally present in the fibers are increased, enhancing their characteristics. The increase of these hydrophilic groups entails a reduction of the crystallinity of the fibers, with a consequent increase in their softness.

This treatment, described above, allows the final product to have an environment-friendly washability and to be chlorine-free.

In practice it has been found that the invention achieves the intended aim and objects, providing a method for providing a layered product obtained from pre-consumption waste originating from products based on camel and/or Cashmere and/or alpaca and/or mohair and/or wool and/or yak and/or the like.

The invention provides a method for providing a layered product obtained from pre-consumption waste originating from products based on camel and/or Cashmere and/or alpaca and/or mohair and/or wool and/or yak and/or the like that has a lower environmental impact than similar methods of the known type.

Furthermore, the invention provides a method for providing a layered product obtained from pre-consumption waste originating from products based on camel and/or Cashmere and/or alpaca and/or mohair and/or wool and/or yak and/or the like that has qualitative characteristics comparable with those of similar layered consumer products composed of virgin high-value fibers.

Finally, the invention provides a layered product obtained from pre-consumption waste originating from products based on camel and/or Cashmere and/or alpaca and/or mohair and/or wool and/or yak and/or the like.

The invention thus conceived is susceptible of numerous modifications and variations, all of which are within the scope of the appended claims; furthermore, all the details may be replaced with other technically equivalent elements.

In practice, the materials used, so long as they are compatible with the specific use, as well as the contingent shapes and dimensions, may be any according to the requirements and the state of the art.

The disclosures in Italian Patent Application No. 102019000004101 from which this application claims priority are incorporated herein by reference.

1.-16. (canceled)

17. A layered product obtained from pre-consumption waste originating from products based on camel and/or Cashmere and/or alpaca and/or mohair and/or wool and/or yak and/or the like, comprising, in percentages by weight:
recovered high-value fibers between 30% and 60%,
tufts of recycled plastic material between 5% and 50%,
tufts of two-part plastic material and with low-melting outside between 8% and 30%.

18. The product according to claim 17, further comprising, in percentages by weight:
substantially 52% camel fibers recovered from garnetted fabric waste, according to the GRS standard,
substantially 28% of recycled polyester tufts according to the GRS standard,
substantially 20% of tufts of two-part plastic material with low-melting outside, with a linear density of 2.2 dtex.

19. The product according to claim 17, further comprising, in percentages by weight:
substantially 52% of camel fibers recovered from garnetted fabric waste, according to the GRS standard,
substantially 23% of tufts of recycled polyester according to the GRS standard,
substantially 25% of tufts of two-part plastic material with low-melting outside, with a linear density of 2.2 dtex.

20. The product according to claim 17, further comprising polyester tufts with a linear density comprised between 1.4 dtex and 6.1 dtex and a length comprised between 30 mm and 70 mm, preferably between 32 mm and 63 mm.

21. The product according to claim 17, further comprising polyester tufts of the type known by the abbreviation 4H.

22. The product according to claim 17, further comprising tufts of two-part plastic material with low-melting outside, with a linear density of 4.4 dtex.

23. The product according to claim 17, wherein said recovered high-value fibers are mixed with virgin high-value fibers and/or vegetable fibers and/or polyester fibers and/or polyamide fibers which are biodegradable.

24. The product according to claim 17, wherein said recovered high-value fibers are mixed with technical fibers based on polyester and elastomers and/or polyester tufts with heat-reactive minerals and/or fibers containing oxides of graphite and/or graphene.

25. A method for providing a product according to claim 17, which consists in:
mixing said high-value fibers with tufts of recycled plastic material and tufts of two-part plastic material with low-melting outside, obtaining a mixed product,
carding said mixed product, obtaining a uniformly mixed and carded layer,
layering said uniformly mixed and carded layer, obtaining a layered product,
stretching said layered product, obtaining a layered product of uniform thickness,
subjecting said layered product of uniform thickness to a thermal bonding operation, melting and mutually heat-sealing at least the external part of said tufts of two-part plastic material so as to form a three-dimensional containment mesh for said high-value fibers and for said tufts of recycled plastic material.

26. The method according to claim 25, further comprising a step of calendering said layered product, subsequent to the thermal bonding operation.

27. The method according to claim 25, further comprising an operation for cutting said layered product, subsequent to the thermal bonding operation.

28. The method according to claim 25, further comprising an operation of rolling up said layered products in fold so as to form a roll of said layered product, subsequent to the thermal bonding operation.

29. The method according to claim 25, further comprising an operation for perforating said layered product.

30. The method according to claim 25, wherein said high-value fibers are obtained from an operation for garnetting said pre-consumption waste, performed prior to the mixing operation.

31. The method according to claim 30, further comprising, between the operation for garnetting the waste and the mixing operation,
an operation for compressing said powder composed of high-value fibers, forming packed blocks,
an operation for opening said blocks, releasing said high-value fibers.

32. The method according to claim 30, further comprising a treatment with ozone and/or oxygen on said high-value fibers after the garnetting operation.
